(19) United States
(12) Patent Application Publication
(10) Pub. No.: US 2016/0003746 A1
(43) Pub. Date: Jan. 7, 2016

(54) CONTROL SYSTEM

(71) Applicant: ISOSPEC TECHNOLOGIES, LP, Houston, TX (US)

(72) Inventors: JACK N MCCRARY, HOUSTON, TX (US); JENNIFER LEIGH FLORES, COLLEGE STATION, TX (US); ALBERT WILLIAMS EARDLEY, COLLEGE STATION, TX (US); JONATHON MICHAEL BEACH, COLLEGE STATION, TX (US); JAKE JEFFERSON TILLERY, COLLEGE STATION, TX (US); SAMUEL CLAYTON WILLIAMS, COLLEGE STATION, TX (US)

(21) Appl. No.: 14/769,508

(22) PCT Filed: Feb. 27, 2014
(86) PCT No.: PCT/US14/18865

§ 371 Date: Aug. 21, 2015

Related U.S. Application Data
(60) Provisional application No. 61/769,933, filed on Feb. 27, 2013.

(51) Int. Cl. G01N 21/65; G01J 3/44

(52) U.S. Cl. CPC G01N 21/65; G01J 3/44

(57) ABSTRACT

The application presented herein focuses on the gas flow control for the evaluation of lactose intolerance but is also consistent with flow control required in diverse applications such as, but not limited to: analysis of other disease states (either using chemical markers or using naturally occurring chemical composition analysis) from breath samples, analysis of chemical concentrations of contaminants in naturals gas production/delivery and in petrochemical processing, analysis of air samples for the detection of drugs and or explosives, detection of chemical composition for the optimization of growth of biological species and or compounds such as in fish farming and or phyto-plancton farming, and finally in the detection of release of carbon dioxide in the determination of an earthquake event.

### BACKGROUND

Diagnosis of concentrations of gaseous and/or liquid samples is accomplished through Analytic Non-Dispersive Raman Spectroscopy—ANDRaS® (a US registered trademark of McCrary, Jack N.) (covered in other patents but included by reference in this application). There is a need for sample conditioning and flow control of gasses (purge/calibration and sample) to and from the spectrometer. The application presented herein focuses on the gas flow control for the evaluation of lactose intolerance but is also consistent with flow control required in diverse applications such as, but not limited to: analysis of other disease states (either using chemical markers or using naturally occurring chemical composition analysis) from breath samples, analysis of chemical concentrations of contaminants in naturals gas production/delivery and in petrochemical processing, analysis of air samples for the detection of drugs and or explosives, detection of chemical composition for the optimization of growth of biological species and or compounds such as in fish farming and or phyto-plancton farming, and finally in the detection of release of carbon dioxide in the determination of an earthquake event.

In order for the system (which includes the ANDRaS® Spectrometer) to function in a real application, there is a further need for a real time display of information that is readily accessible by the user to review the data created through the analysis of all previously described analysis. Furthermore, all data may be desired by remote users such as field service technicians for the use in diagnosing problems with the instrument and/or by users such as doctors or scientist that are located remotely from the actual spectrometer such that a remote application using wireless technology is also included for all applications of the ANDRaS® Control System.

The ANDRaS® Control System (ACS) overview will help us convey the customer's functional requirements as well as how the device is designed to meet those requirements. In order to better describe the ACS, ITR has created a Conceptual Diagram as shown in FIG. 1. This diagram shows how our control system and software will interact with the ANDRaS® spectrometer. Everything highlighted with a blue outline and light blue background indicates components that are part of our system.

The ANDRaS® Control System consists of various electronic circuits and mechanical controls. The purpose of these systems is to allow the measurement of lactose intolerance with the use of a breath sample. Performing this measurement requires several steps. The first step the machine completes is the purge cycle. The purge gas cylinder, seen in section A of FIG. 1, is controlled with the electromechanical hardware seen in sections B, C, D, E and F of FIG. 1. Before the purge cycle begins, the pressure of the gas cylinder is tested using a pressure sensor that is represented in section B of FIG. 1. This pressure is controlled by the regulators seen in section C of FIG. 1. The purge gas flow is controlled with an electromechanical valve, seen in section D, that will open during the purge cycle. The chamber is evacuated using the sample/vacuum pump shown in section D of FIG. 1, then the exhaust valve, seen in section E, will also open to release the gas. After the purge cycle, the next procedure is to calibrate the system. Mechanically, the calibration process is the same as the purge process, except the exhaust valve closes after a set amount of time and the pressure is allowed to increase to user set pressure in the ANDRaS® chamber, before a spectroscopic measurement is taken. After the calibration process, the system goes through another purge cycle using the above method for purging. After evacuation of the chamber, the patient sample is inserted through the ANDRaS® Input Valve and tested by the ANDRaS® seen in section F. ANDRaS® requires that the patient measurement be taken with the sample pressurized to a user set pressure. This requirement will be met using the sample/vacuum pump. The sample pump will pump the sample into the chamber while the ANDRaS® Input Valve is open. After the measurement has been taken, another purge cycle is needed to clear the chamber.

The hardware control board, as mentioned above and seen in section G of FIG. 1, will be responsible for controlling the electromechanical valves and the pump that will drive the above mentioned cycles. Specifically, the microcontroller will interface with the electromechanical devices via circuitry that will allow the low voltage, low current outputs of the microcontroller to control the higher voltage, higher current devices. Logic-level MOSFETs are used to interface the microcontroller to the electromechanical valves. The hardware control board is responsible for interpreting the output of the ANDRaS® chamber. The output of the spectrometer will be a series of high speed pulses that indicate every photon that hits the sensor. The microcontroller will be able to count these values over a period of time and determine the chemical concentration of the sample. After the measurement has been taken using the above methods, the results are transmitted to a tablet that runs LabVIEW™ control software. Data will be transmitted via Bluetooth® as seen in section H of FIG. 1.

The tablet has a touch screen that allows user interaction with the LabVIEW™ GUI. The tablet is also responsible for wireless control of the hardware control board using Bluetooth® communications. A sample test is started by pressing the start button on the LabVIEW™ GUI and entering the patient ID. Once a test has completed all cycles, the tablet will acquire the sample data. This data is sent to the Android™ User Application shown in section I of FIG. 1. The data will also be stored locally on the tablet. The Android™ User Application shows the data for the patient over time to the opporatorr. The tablet will also monitor the status of the ANDRaS® Control System and send alerts to an Android™ Maintenance Technician application, shown in section I, to inform the technician that the ACS needs repair.

### Problem Statement/Scope

Currently, the application of the ANDRaS® spectrometer used as a lactose intolerance diagnostic tool is limited to a research environment due to the raw data output and lack of a flow control system. Development of a flow control system as well as user interfaces are needed for use in the medical field. The ACS will be able to analyze the raw data output from the ANDRaS® and convert/display the results in a readable format for Operators and Maintenance Technicians.

### Functional Requirements

1. Interface

Touchscreen—The ACS requires the use of a touch enabled screen that will allow for user interaction with the graphical user interface. Graphical User Interface, Tablet—The ACS will be controlled using a graphical user interface. Graphical User Interface, Remote Devices—The remote devices will display data, from the ACS, using graphical user interfaces.

2. Communication

Wireless communication with Internet—The tablet will communicate with a wireless access point to contact a remote device. Short range data communication—The tablet will communicate a short distance to and from the internal control board of the ACS.

3. Hardware

Power—The ACS will be AC powered and will provide AC power to the ANDRaS® chamber. ACS input—The internal control board will count high-speed TTL pulses. Shutter control—The system will provide shutter control lines for expandability. Electromechanical control circuitry—The microprocessor will control electromechanical devices.

4. Mechanical

Plumbing—The ACS will use tubing in order to control the flow of gas throughout the system. Sensors—Sensors will be placed in various locations in order to monitor the system status. Valves—Valves will be used in the ACS for flow control of gases. Enclosure—The ACS will be contained within an enclosure.

5. Remote Device Software

The remote device software will receive and display information from the ACS. User application—The ACS will have a user application that is able to receive results from the tablet. Maintenance Technician application—The ACS will have a Maintenance Technician application that will receive notifications from the system.

### Design Implementation Strategy and Overview

1. Hardware

Based on the challenge presented by the control system design the ACS will use a Texas Instruments (TI) MSP430F5521 and a Roving Networks RN-42 Class 2 Bluetooth® Module to interface the analog inputs to the ACS to the user interface tablet.

2. Embedded Software

The embedded software is written in TI's embedded C for the MSP430 Microcontroller Unit (MCU). The MCU itself is the electrical interface between the LabVIEW™ software and the electromechanical system. The MCU is responsible for executing commands from LabVIEW™ and sending the results back. The software is written as a command processor with minimal logic to reduce the need to re-flash the MCU when system logic is updated.

3. LabVIEW™

LabVIEW™ has been specified as a GUI for the ACS interface. It was requested by the customer that it be to start modifying the program and provides less training to use than a traditional programming language. This GUI is responsible for sending commands to control the ACS as well as displaying patient information, test results, and providing maintenance operations. The GUI provides two operation modes, Lab Technician and Maintenance Technician. The Lab Technician mode allows the operator to add, delete, and select patients, tests, and samples. The Lab Technician is also able to run tests on patient samples, retrieve test results, and send the test results to the user's Android™ application. LabVIEW™ stores the data in a MySQL database once a Lab Technician has entered the data. The Maintenance Technician's access is protected with a password and only allows access to the maintenance screens, not patient data. The maintenance screens allow the technician to debug the machine by controlling the individual components as well as changing settings related to ACS operation. The LabVIEW™ program is also required to prevent ACS operation by the Lab Technician during error states.

4. Android™ User Application

The User's Android™ application for the ACS is designed to register the operator to the ACS, get notifications of when a test is done and display the results, and also be able to query test results of a certain patient if the opportator knows their test information.

5. Android™ Maintenance Technician Application

The Maintenance Android™ application for the ACS is designed to register the maintenance technician to the ACS, get notifications of when an error has occurred and display the error, and also be able to query the datalog ID of a certain error if the maintenance technician knows the specific datalog ID.

### System Requirements

1. Hardware

The ACS will be required to run on 120VAC (wall power) and will not require and battery backups, although for the intent of this patent application, battery backup/power sources are also considered. The inputs to the ACS, as pertaining to the hardware, will be up to eight sensors with a voltage range of 0-5VDC. The TI MSP430F5521 will be required to control, via FET switches, up to eight valves and three solid state relays. As requested by the customer there will be eight shutter lines for future expansion.

2. Embedded

The LabVIEW™ software is responsible for controlling the ACS. For LabVIEW™ to perform its task, it needed an electrical interface. The MCU running the embedded software is responsible for interpreting the command sent from LabVIEW™ through the Bluetooth® serial link. The microcontroller is responsible for measuring four analog pressure sensors which supply a voltage ranging from zero volts to five volts over their pressure range. It is also responsible for controlling electromechanical valves and 120VAC. The MCU is responsible for interfacing with ANDRaS®. It counts the number of pulses produced by the ANDRaS®, at speeds of up to 20 MHz, over a period of time to determine concentration. The microcontroller is not responsible for converting counts to a parts per million concentration. The microcontroller will not perform the actual test sequence or other logic functions as this will be implemented in the LabVIEW™ program.

3. LabVIEW™ Graphical User Interface Software

A LabVIEW™ graphical user interface is required by the customer for ease of development and maintenance. ITR has developed a LabVIEW™ program that operates on an Intel x86 Windows 8 Pro tablet that provides control logic to the embedded software and provide a user interface to the system. The LabVIEW™ program is designed to contain all of the system logic so that a system update would only require updating the LabVIEW™ executable and not the firmware. The user interface must allow patient data to be entered and stored and tests to be run on the patient's breath sample. Storage of the patient data and test results will take place in a MySQL database. The user interface must also accommodate debugging of the ACS system and support maintenance such as showing system pressures, allowing control of individual components, and keeping a data log.

4. Android™ System

The purposes of the Android™ applications are to notify the user when a test is finished and to notify the maintenance technician if there is an error with the ACS. The User Android™ application will need to communicate over a 256-bit encrypted channel so that the system can be HIPAA compliant. The user application will also need the ability to query the database if the user knows the patient's test information. The maintenance technician application will need to be able to receive notifications over an unencrypted line so the maintenance technician can be dispatched if there a problem with the ACS. The maintenance technician application will also need the ability to query the ACS database if the maintenance technician knows the error information.

5. Enclosure

Although other configurations and materials are considered, the enclosure for the ACS was specified to be made from steel, accommodate the ANDRaS® device with power and gas flow, and have outside dimensions of 10″×10″×12″±2″. To begin the enclosure design all of the parts for the electromechanical system were purchased in order obtain exact dimensions for each part, including power plugs and gas tube fittings. Each part was then modeled in SolidWorks 2013 according to their outside dimensions.

### Performance Specifications

1. Interface

Tablet—Built-in Bluetooth® v2.0 Support, Built-in 802.11 b/g/n wireless communication Graphical User Interface—Lab Technician interface must be: inaccessible to Maintenance Technician, Password protected, Patient's identification (Patient's name, Patient's address, Patient's date of birth, Patient's sample identification, Patient's sample number, Patient's test identification), Graph of analysis, Status indicator for test. Maintenance Technician interface must be: Inaccessible to Lab Technician, Password protected, show readings (Valve indicators, Pump indicator, Pressure indicators, Fault indicator), Process settings (Purge, Calibration, Sample), have Error log screen, have Low tank warning (Fault errors).

Graphical User Interface, Remote Devices—User application—The GUI will be a touch-enabled Android™ application and will allow the operator to view: Patient's identification, Patient's test identification, Patient's name, Patient's address, Patient's date of birth, Patient's test results, Graph of analysis.

Maintenance Technician Application—The GUI will be a touch-enabled Android™ application and will allow the operator to view: Error log identification, Error code, Error description, Error date, Valve state, Shutter state, Solid State Relay state, Calibration pressure, Purge pressure, Regulated pressure, ANDRaS®pressure, Count value, Time.

2. Communication

Wireless Communication with Internet, User application—Patient data received within 30 minutes of sample analysis completion, Wireless communication rate of at least 1 Kb/sec, Encrypted using SSL. Wireless Communication with Internet, Maintenance Technician application—Alerts received within 30 minutes from the time of a detectable malfunction of the ACS, Wireless communication rate of at least 1 Kb/sec.

Short Range Data Communication—At least 500 bits/sec at 128 bit encryption.

3. ACS Hardware

Power—ACS powered by 120VAC, ACS provides switched 120VAC power to ANDRaS®, 2 A minimum current, Zero-crossing switching.

High Speed Counting—Signal from ANDRaS® will input at a maximum of 20 MHz, Minimum high pulse width detection of 30 ns, Maximum count value of 32 bits, 30 second maximum count time, ±0.1% accuracy.

Shutter Control—8 TTL shutter control lines, 10 mA source/sink.

Electromechanical Control Circuitry, Valves—3.3VDC control line for switching 12VDC, Control 6 valves independently.

Electromechanical Control Circuitry, Pumps—3.3VDC control voltage to 12VAC, Supply 3.8 A to the pump, Control system pump and ANDRaS® power independently.

Electromechanical Control Circuitry, Gauges—Output of 0 to 5V, Signal conditioning for interface to microcontroller A/D, Read 4 gauges independently.

4. ACS Mechanical

Pressure Sensor—Output voltage range from 0 to 5 VDC, Pressure range from 0 to 2000 psig, Sensors can be polled as needed by the control GUI, Sampled using microcontroller A/D converter with a signal conditioning circuit.

Vacuum/Pressure Sensors—Output voltage range from 0 to 5VDC, The sensor can measure from 0 to 200 psia, Sensors can be polled as needed by the control GUI, Sampled using microcontroller A/D converter with a signal conditioning circuit.

System Pump—Can pressurize a chamber up to 60 psig maximum pressure, Will be controlled by the microcontroller, Pump has a Teflon diaphragm, Power for the pump is 120VAC and 60 Hz.

Three Valve Manifold Low Pressure Assembly—Each valve is powered using 12VDC, Power will be provided and controlled using a power FET circuit controlled by the microcontroller, Normally closed valves, Operating pressure from 0 to 30 psi

High Pressure Valves—Valves are powered using 12VDC, This power will be provided and controlled using a power FET circuit controlled by the microcontroller, Normally closed valves, Operating pressure from 0 to 100 psi.

5. ACS Embedded Software

UART—Communicate at least 9600 bits/sec with Bluetooth® module, 0 and 3.3 voltage levels.

Digital—0 and 3.3 voltage levels for interface circuitry, 24 digital I/Os, 8 lines for shutter control, 3 lines for pump control, 8 lines for valve control, 5 lines (includes RTS and CTS) for Bluetooth® control.

Timer—1 Timer External Clock input pin to count pulses.

Analog—8 analog inputs, Input range from 0 to 3V, 12 bits of resolution.

Android™ User Application—Receive patient test information, Request information from database.

Android™ Maintenance Technician Application—Receive error information, Request information from database.

### Serial Communications

1. Universal Asynchronous Receiver Transmitter (UART) Serial Connection

The LabVIEW™ software communicates through an emulated serial port on the computer to the microcontroller's UART using a transparent Bluetooth® link. This connection is seen at both ends as nothing more than a serial link running at specific parameters. The serial communication ACS uses is 57600 baud, 8 bit char, no parity, no flow control, and one stop bit.

2. Packet Protocol

The line level framing is carried out by the UART however, LabVIEW™ and the embedded code use a custom packet to communicate data over the serial link. This packet specification was created to be simple yet provide error checking. FIG. 2 shows the format for a general packet.

### Hardware Design

1. Functional Block Diagram

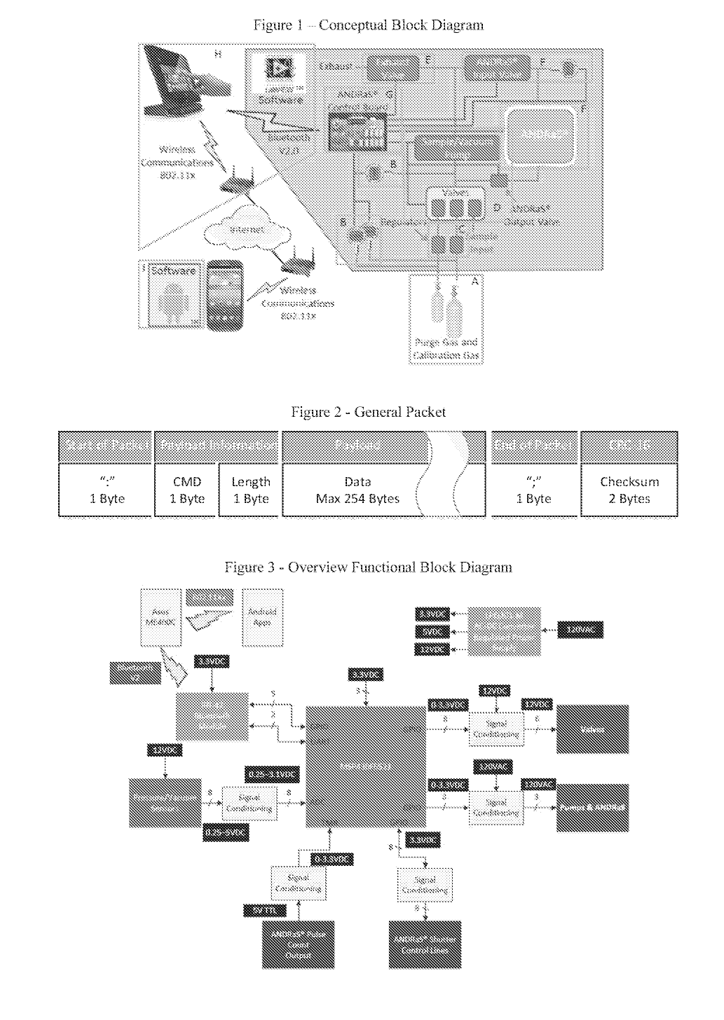

The Overview Functional Block Diagram depicts the way the system will interact with different sub-systems. The Overview Functional Block Diagram in FIG. 3 will breakdown the ACS into sub-sections and trace the flow of power, communications, and general pin layouts.

2. ANDRaS® Input

The ACS must have the ability to detect and count the pulses that are received from the ANDRaS®. The MSP430 Timer A External Clock input is 0V to 3.3V; however the ANDRaS® count output is a TTL signal. To interface the count output line to the MSP430, the PCB will use a voltage divider. The MSP430 will count the number of pulses from the ANDRaS® as it makes sample measurements.

3. Bluetooth Communications

The ACS will have internal control circuitry that will need to communicate wirelessly to the tablet. A Bluetooth® communications module has been selected to satisfy the wireless communication with the tablet. The communications section of our circuit includes an RN-42 Bluetooth® module, communication and control lines from the MSP430, and status LEDs. The Bluetooth® module communicates to the MSP430 through the use of the UART port.

4. Pressure/Vacuum Sensors

The ACS will need to determine the pressure of the purge and calibration gases as well as the ANDRaS® chamber pressure and vacuum. Both pressure sensors and the pressure/vacuum sensor output a voltage range that represents the pressure/vacuum that the sensor is currently measuring.

5. Valve Control

The ACS must be able to control the flow of the gases that are used during the testing process. This will be done using multiple electro-mechanical valves. The ACS will be using GPIO pins from the MSP430 to control the NResearch solenoid valves via MOSFET valve control circuitry.

6. Pump Control

For some operations of ANDRaS®, the incoming sample has to be pressurized up to 100 psi. although all other pressure ranges are considered in this application. After a sample is taken, the ANDRaS® will need to be evacuated. This will be done using a provided vacuum pump. The MSP430 does not have the capability to directly control 120V AC, thus we must convert the low voltage output of the MSP430. The MSP430 GPIO lines will connect to the solid state relay that will allow for the controlling of the high voltage side. Actuating a pump will only require that the corresponding GPIO line be set to a high state.

7. Electromechanical System

The stakeholder for the ANDRaS® Control System needed a system that could force the flow of three different types of gases into and out of the chamber of the ANDRaS®. Although the current design uses three gasses as input sources, any number of gas samples and concentrations are considered under this application. From this one statement, ITR concluded that the system would need a system pump capable of pulling a vacuum and pressurizing a small chamber, the system would need several different types of isolation valves and finally a series of sensors in order to observe the pressures within the system itself

8. The System Pump

The system pump was required by the stakeholder to be able to apply 60 psig to the ANDRaS® chamber and be able to pull up to 23InHg of vacuum. The pump that was selected is a general purpose pump purchased from Air Dimensions, Inc. The R271 also comes with a stainless head as well as Teflon wetted material within. These materials allow for the least amount of contamination to the patient sample during testing.

9. The System Manifold

The System Manifold is a straight through manifold with three injection valves. These three valves are 12VDC solenoid valves that can handle pressures from absolute vacuum to 30 psig. This manifold is constructed from stainless steel and all wetted material is made of Teflon, once again in order to not contaminate the sample input to the ACS.

10. High Pressure Isolation Valves

The ANDRaS® Exhaust, ANDRaS® Input, and ANDRaS® Output valves were also all purchased from NResearch.com. Each of these three valves were to be pressurized to that of the System Pump's capability. Due to this factor these three valves are considered HP or High Pressure isolation valves. Each one can withstand a pressure range from absolute vacuum to 100 psig. Each valve is a normally closed solenoid energized at 12VDC and is constructed from stainless steel and Teflon for wetted material.

11. High Pressure Regulators

The stakeholder has a requirement that the ACS be able to take input from two high pressure compressed gas bottles that held at least 2000 psig. The high pressure gas regulators used in the ACS are made by Harris. Each regulator is made from solid brass and comes with three regulated output ports. Each regulator has the ability to regulate 3000 psig down to 0-250psig at the outputs.

12. High Pressure Transducers

Each regulator is equipped with a High Pressure Transducer on the high input side in order to track each high pressure bottle's pressure.

13. Low Pressure Transducers

The Regulated Pressure sensor and the V/P Gauging sensor are both considered Low Pressure Transducers. The Regulated Pressure sensor has a range of 0-250 psig and is used to watch the pressure within the system before reaching the System Pump. This sensor is used to watch the pressures within the ANDRaS® chamber whether it be a positive or negative pressure.

### Software Design

1. Embedded

The embedded code is written for an MSP430 and is responsible for responding to received commands and providing system information. The embedded software is written with an interrupt based architecture that uses minimal polling to get the state of certain peripherals. The MSP430 is charged with four major operations: reading the analog pressure sensors, counting pulses from the ANDRaS®, responding to commands from LabVIEW™, and controlling electromechanical devices. The system logic and testing logic resides in LabVIEW™ and reduces the need to re-flash the microcontroller when logic changes. Timer B is used to produce software ticks that are used to schedule and time processes. This Interrupt Service Routine (ISR) is responsible for scheduling status packets, notifying the main loop when counting is done, detecting a serial timeout, starting ADC conversions, and sending ACK packets. Timer A is used to count the number of pulses produced by ANDRaS®. The ISR for this timer increments a long unsigned integer in case the amount of pulses is greater than the timer's register. The microcontroller reads the analog pressure sensors using the built in 12 bit Analog to Digital Converters (ADC). There are eight total ADC channels populated on the board and four are in use. These channels are setup to sample sequentially 50 times giving a 50 sample average for each measurement.

A system protection feature was also added so that if serial communication was lost the pumps and valves would be shut off. This is accomplished by having a keep alive packet time out. If the microcontroller does not receive this packet in time it assumes the connection is lost and turns off the valves and pumps. The embedded code was written to be easy to modify. The C file is accompanied by a header file where the pins for the valves, shutters, and pumps can be setup. The header file also contains other system settings. The header file is commented heavily so that it is easy to understand.

2. LabVIEW™

The LabVIEW™ code was designed to act as the system logic, testing logic and provide a user interface for the Lab Technician and Maintenance Technician. These two separate displays allow for user permissions to separate patient data from the Maintenance Technicians and to only allow the Lab Technician to access the normal functions of the ACS. The Lab Technician has his/her own login that brings them to the testing displays of the ACS: Patient management, Test management, Sample management, and the Testing screen. From this screen data can be entered about the patient and the test being performed at which point it will be stored in the MySQL database. Once all of the data has been entered the Lab Technician can run the test which will start the testing state machine. The Maintenance Technician has a separate login that allows access to the main debug screen, the datalog screen, and the settings screen. While logged in as a Maintenance Technician he/she will have no access to patient data.

3. MySQL

A MySQL database is used to store all of the patient data and system information for later retrieval. This database consist of multiple tables to store each part of the patient's data. Tables relevant to patient data are patients, tests, and samples. The database is setup using foreign keys to link each of the tables. These foreign keys insure data integrity by updating tables that are linked together. Only one table has a unique key, the patient ID table. This prevents duplicate patients based on IDs. The tests and samples table do not have unique keys but the combination of the test ID and the patient ID or the test, sample, and patient ID create a unique key for the tests and samples tables respectively. Because of the unique keys and the foreign key link from samples to tests, and from tests to patients, if a patient gets deleted all test and samples will also be deleted. If a test is deleted from a patient then all samples associated with that key also are deleted. The same holds true for updates to the keys for each of the tables, the changes will be cascaded down.

4. Android™ User Application

The user's Android™ application for the ACS is designed to register the operator to the ACS, get notifications of when a test is done and display the results, and also be able to query test results of a certain patient if the operator knows their test information. To be able to receive messages from the ACS, the user first needs to register his or her device to the ACS. Once the operator is registered to the ACS server, they can then receive test results from the system. Since the server is configured to connect on an SSL connection, the communication will be encrypted and HIPAA compliant.

5. Android™ Maintenance Technician Application

The Maintenance Android™ application for the ACS is designed to register the maintenance technician to the ACS, get notifications of when an error has occurred and display the error, and also be able to query the datalog ID of a certain error if the maintenance technician knows the specific datalog ID. To be able to receive messages from the ACS, the Maintenance Technician first needs to register his or her device to the ACS. Once the technician is registered to the ACS server, they can then receive errors from the system. Since the server is configured to connect on an SSL connection, the communication will be encrypted and HIPAA compliant.

6. Server Code

The server code is designed to be an interface between the Android™ applications and the ACS database. When the Android™ applications send a POST to the ACS server, it is to a specific URL, which will include the IP address of the server and the file on the server that will return the correct information.

### Hierarchy Flowcharts and State Machines

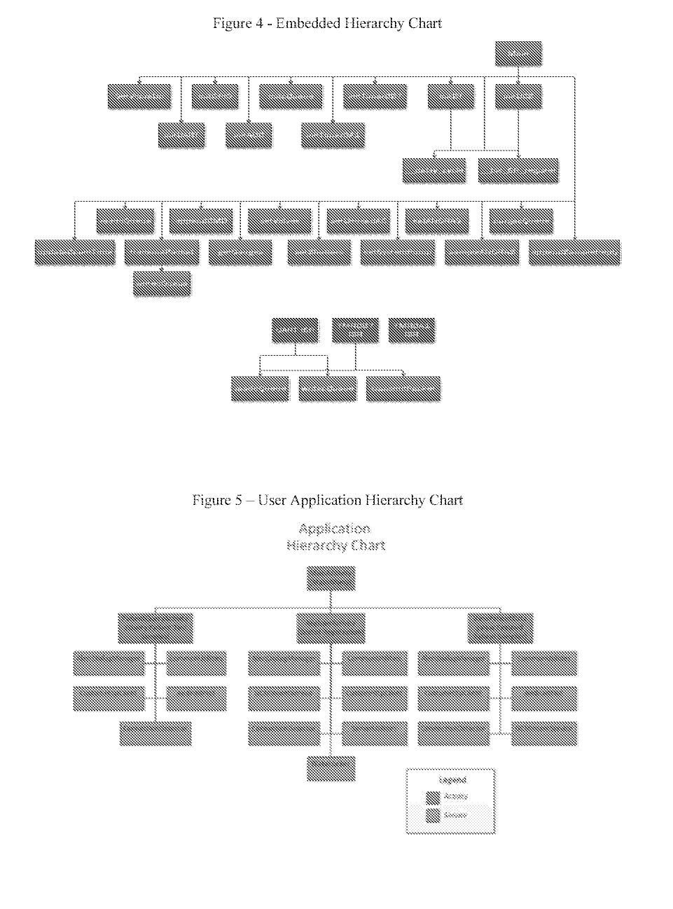

1. Embedded: ITR has developed a hierarchy chart to help in the planning and explanation of the code. FIG. 4 shows the hierarchy chart for the MSP430 embedded software. The top part of the hierarchy chart is for the main program and its function structure. At the bottom of the hierarchy chart are the three interrupt service routines shown in red. These have no direct calling relation to any specific function so they are shown independently.

2. Android™ User Application: A hierarchy chart is used to aide in software planning and shows the calling hierarchy of each function. FIG. 5 shows the Hierarchy Chart for user application. As is shown in the chart, the green boxes indicate activities and the blue boxes indicate the services and libraries that the activities use.

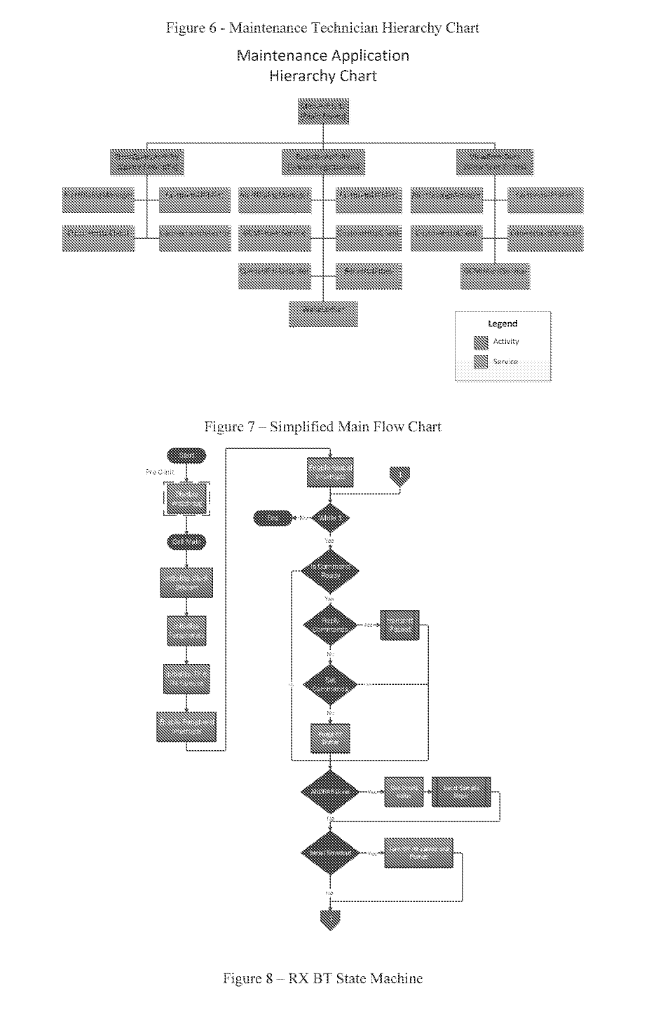

3. Android™ Maintenance Technician Application: A hierarchy chart is used to aide in software planning and shows the calling hierarchy of each function. FIG. 6 shows the Hierarchy Chart for user application. As is shown in the chart, the green boxes indicate activities and the blue boxes indicate the services and libraries that the activities use.

4. Main Flow Chart: The Embedded Main Flow Chart shown in FIG. 7 shows a simplified version of the actual system. The main loop is where the command processor resides as well as several other processors. Once C has initialized the system then Main is called. Main first initializes all of the variables and the peripherals. Then it enters the endless while loop. Within this while loop a cmdReady flag is checked. If this flag is set then a command is ready for processing. If the flag is not set or the command processing is done then it proceeds to check two more flags, ANDRASDone and serialTimeout. If sampling has finished then it sets the ANDRASDone flag and the results are processed and sent back to LabVIEW™. If the serialTimeout flag is set then the system did not receive a keep alive packet within the allotted time and the pump and valves are shut off and the user is prompted of the time out.

5. RX State Machines

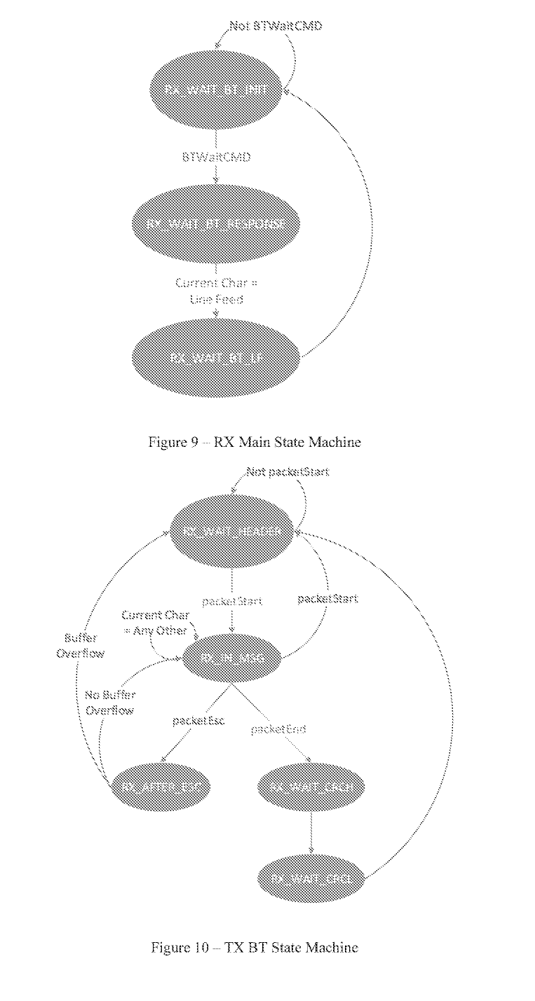

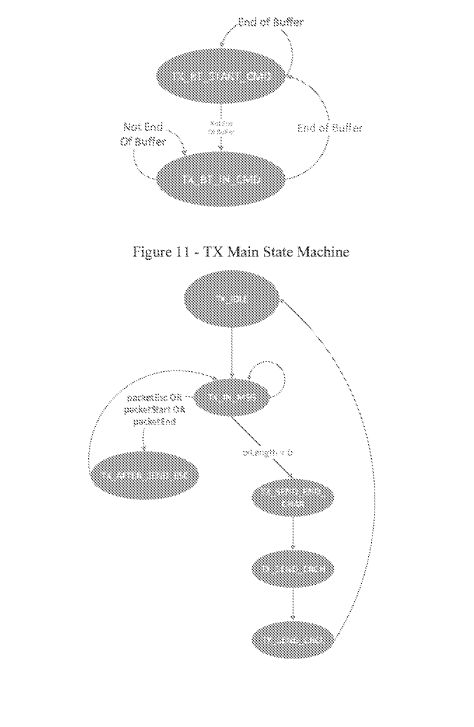

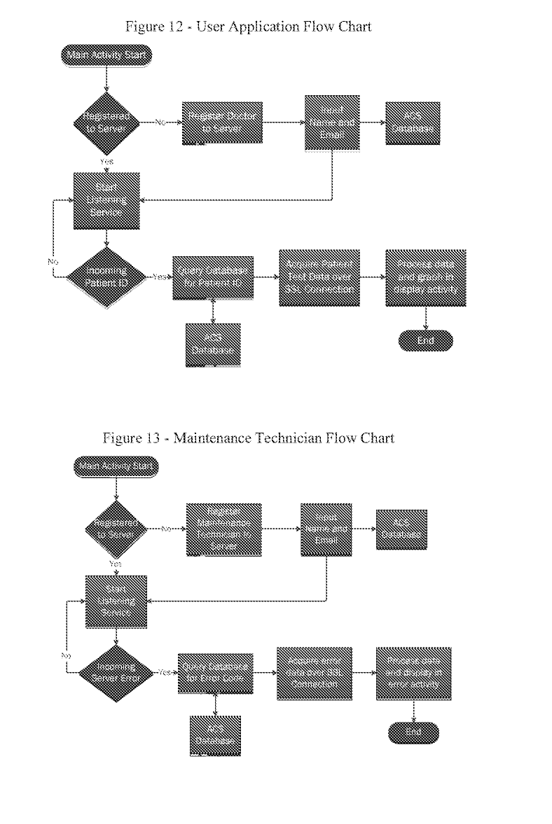

The RX state machine has two separate inner state machines: a Bluetooth® communication state machine and a LabVIEW™ communication state machine. The LabVIEW™ state machine is responsible for receiving incoming packets and detecting errors with those packets. With the current state machine and packet configuration, several errors can be detected. It can detect cutoff packets, buffer overflows, bad packets by length, and bad packets by a 16 bit CRC. FIG. 8 shows the state diagram for the Bluetooth® state machine. The Bluetooth® RX state machine is a simple state machine that is designed to receive command responses from the Bluetooth® module. This state machine has no interaction with LabVIEW™ or the LabVIEW™ packet state machine. The Bluetooth® RX state machine starts in the RX_WAIT_BT_INIT state until the flag BTWaitCMD is set and a character is received. Once this occurs, the BTCMDrxBuffer is cleared and the character placed into the buffer. The state machine then advances to the RX_WAIT_BT_RESPONSE state. In the RX_WAIT_BT_RESPONSE state, the incoming char is put in the buffer. Then if the character in the buffer is a Carriage Return (CR), the state machine advances to the RX_WAIT_BT_LF state. If the character is not a CR, then it stays in that state.

Once in the RX_WAIT_BT_LF state, the next character is put in the buffer, the BTCMDReady flag is set, and the BTWaitCMD flag is cleared. The state machine then returns to the initial state. The second state machine interacts with the packets from LabVIEW™. Error! Reference source not found. 9 shows the packet state machine.

This state machine is used to receive the packed-based communication protocol. The advantage to using this state machine and a packet approach is that it provides error protection. The first state is the RX_WAIT_HEADER which waits for a packetStart char, “:”, to be received. At this point, it sends the CRC with 0xFFFF and clears the rxBuffer. The state machine then progresses to the next state, RX_IN_MSG. The RX_IN_MSG state is responsible for most of the packet processing. When a character arrives in the RX_IN_MSG state, it can be a packetEsc, packetStart, packetEnd, or other. When the character is:
packetEsc the next state is set to RX_AFTER_ESC, nothing else is done.
packetStart then the packet is not a valid packet because the packet was cutoff This is the place to handle a bad packet by cutoff error. This error returns us to the RX_WAIT_HEADER state.
packetEnd then the packet data is done we can expect the high and low bytes of the crc next. This sets the next state to RX_WAIT_CRCH.
Any other character that is received is placed in to the RX buffer and the crc is calculated. The state machine stays in this state.

After the state machine enters the RX_AFTER_ESC state, the next character received is inserted into the RX buffer, the crc is calculated, and the next state set to RX_IN_MSG. If the buffer overflows, then the next state is set to RX_WAIT_HEADER.

The RX_WAIT_CRCH state waits for a character, and when it is received, the function shifts the value by 8 bits and stores it in rxCRC. This then sets the next state to RX_WAIT_CRCL.

The RX_WAIT_CRCL state receives the current character and adds it to rxCRC, and stores it into rxCRC. Then the measured length is compared to the received length; if they do not match then the length error is handle. If the length passes, then the calculated CRC is compared with the received CRC; if this fails, then the CRC error is handled. If there are no errors and the ACK packet is ready to be sent, the RX buffer is copied into the rxCMDQueue. The cmdReady flag will then set and the state machine is set to RX_WAIT_HEADER.

6. TX State Machines

The TX state machine has two separate state machines: a Bluetooth® communication state machine and a LabVIEW™ communication state machine. The Bluetooth® state machine is not currently used but is provided in case the Bluetooth® module needs to be configured later on. The LabVIEW™ state machine is responsible for transmitting outgoing packets. FIG. 10 shows the Bluetooth® state machine. The Bluetooth® state machine is a simple state machine designed to transmit bytes in a buffer to the Bluetooth® module. This state machine is used when the Bluetooth® module needs to be configured and is currently not used. When a command is ready to be sent, the TX interrupt is triggered and the TX_BT_START_CMD runs. When this happens, the BTCMDtxBuff is set to the beginning and the current character is transmitted. The buffer is incremented and checked if it is the end of the buffer, and if so, it stays in the TX_BT_START_CMD state. If it is not the end of the buffer, then it sets the state to be TX_BT_IN_CMD.

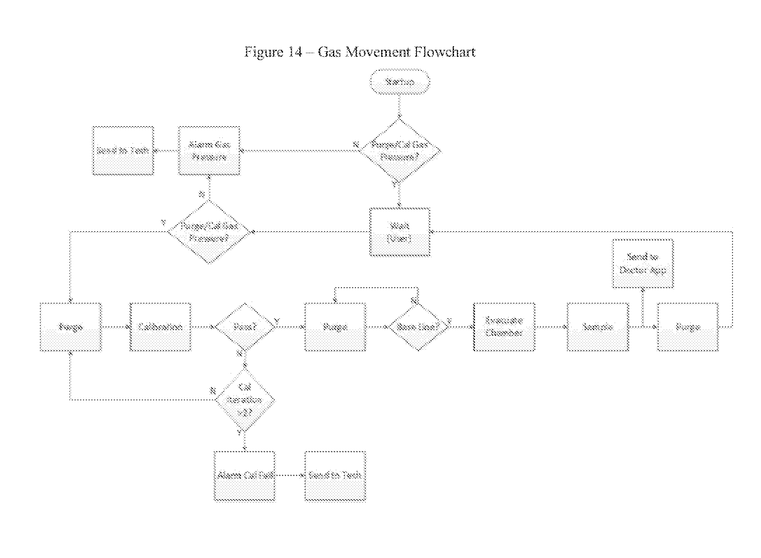

When another character is ready for transmitting, the TX_BT_IN_CMD state transmits the character and increments the buffer. If the buffer is at the end then it sets the state to the TX_BT_START_CMD. If the buffer is not empty then it stays in this state. The state machine used for the packet protocol that communicates with the LabVIEW™ is shown in FIG. 11.

### Applications

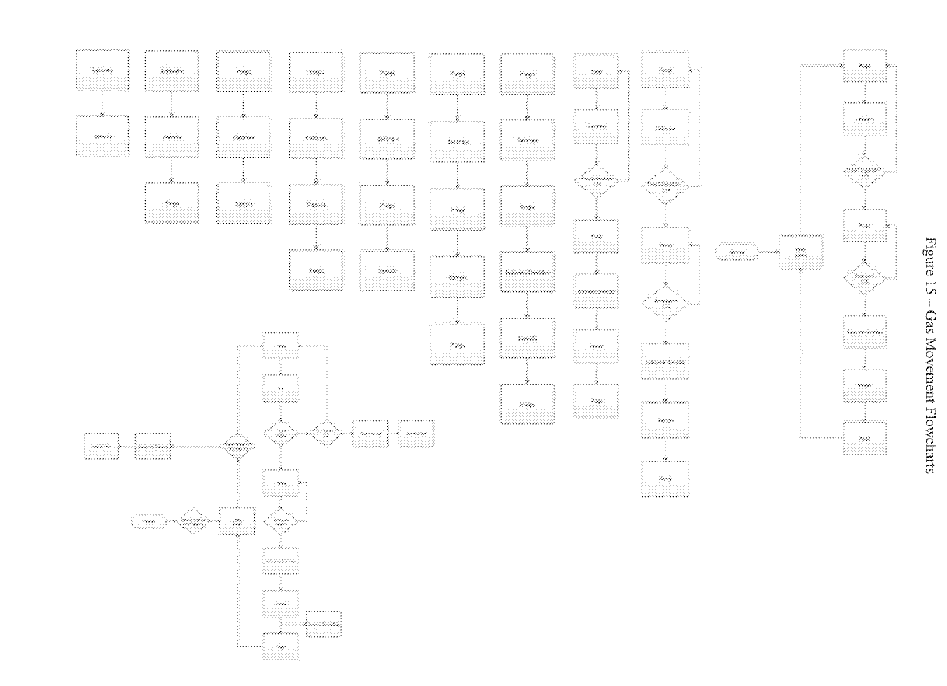

1. Android™ User Application: Flow diagrams are used to plan the logical flow of the software. Flow diagrams allow the programmer to see how each aspect of the program interacts with each other. FIG. 12 shows the flow diagram for the high level functionality. This flow chart shows the high level life cycle of the user application. First, the program will start. Then if the operator is not registered to the ACS, they will have to enter their name and email which will be sent to the ACS database. Once that is done, the application will wait for a notification from the ACS that a test is complete. If there is an incoming notification, then the user will click it and the application will query the ACS database. When the information is received over the SSL connection, the data will be processed and displayed in the ViewPatientData activity. Last the cycle will end.

2. Android™ Maintenance Technician Application: FIG. 13 shows the high level life cycle of the maintenance application. First, the program will start. Then if the maintenance technician is not registered to the ACS, they will have to enter their name and email which will be sent to the ACS database. Once that is done, the application will wait for a notification from the ACS that a test is complete. If there is an incoming notification, then the user will click it and the application will query the ACS database. When the information is received over the SSL connection, the data will be processed and displayed in the ViewErrorData activity. Last the cycle will end.

### Conclusion

Again, the preceding is not considered to disclose every possible application of the disclosed invention, but merely to provide one or more embodiments of how the invention works and may be put into service. As such, although described throughout with reference to particular embodiments, one skilled in the art with this disclosure, could apply these teachings to many different technical areas and each is intended to be included herein.

What is claimed is:

1. All information/methods and systems disclosed above.
